(19) United States
(12) Patent Application Publication
(10) Pub. No.: US 2005/0285771 A1
(43) Pub. Date: Dec. 29, 2005

(54) Device for protecting objects against ammunition in the form of guided missiles

(76) Inventor: Helmut Jahn, Kaufungen (DE)

Correspondence Address: Robert W Becker & Associates, Suite 7, 707 Hwy 66 East, Tijeras, NM, 87059-7382, US

(21) Appl. No.: 10/530,940

(22) PCT Filed: Oct. 1, 2003
(86) PCT No.: PCT/DE03/03271

§ 371 Date: Apr. 8, 2005

(30) Foreign Application Priority Data
Oct. 10, 2002 (DE) 10247350.1

(51) Int. Cl. G01S 7/36

(52) U.S. Cl. 342/13

(57) ABSTRACT

The invention relates to a device for protecting objects against ammunition in the form of guided missiles, said device comprising warning sensors (1) for detecting an approaching missile and active elements (2, 3a) for repelling the missile. The sensors (1) and the active elements (2, 3a) are arranged on a common appliance carrier (5) which can be arranged or mounted on the object to be protected. Preferably, a plurality of sensors (1) are arranged on the appliance carrier (5), and firing devices (3a) which can be at least upwardly oriented and are used to fire active elements are arranged in the region beneath the warning sensors. A unit (2) of electronic/electro-optical active elements can be arranged on the appliance carrier (5) in the region above the warning sensors (1) in such a way that it can at least be oriented in an azimuth direction angle.

The invention relates to an apparatus for protecting objects against ammunition in the form of guided missiles, and includes warning sensors for detecting an approaching or incoming guided missile, as well as active elements for repelling the guided missile.

Considered as objects in this connection are not only vehicles, especially combat vehicles, but also stationary facilities such as small buildings, transportable shelters, and the like. It is known to realize protection systems, which are effective from a distance, by independent integration of warning sensors and active elements on the object that is to be protected. This leads, in particular with vehicles, to relatively expensive and complicated retrofitting approaches, since with the integration of the individual components, respectively extensive adjustment steps and very precise mechanical machining on the surface of the vehicle must be carried out.

It is an object of the invention to embody an apparatus of the aforementioned type in such a way that a self-sufficient, self-protecting platform results that can be adapted to the objects and serves for protection all the way around against ammunition in the form of guided missiles.

The realization of this object is inventively effected in that all of the warning sensors required for the detection, and all of the active elements necessary for the repelling, are disposed on a common device carrier that is disposed on the object that is to be protected or can be mounted thereon.

It has shown to be particularly advantageous if at least one warning sensor is disposed on the device carrier, and in the region below the warning sensor or warning sensors, firing devices for active elements that can be fired or launched, and which can be adjusted at least in elevation, are disposed in such a way that the field of viewing of the warning sensor or warning sensors is not limited in azimuth and elevation.

The basic concept of the invention is that not only the sensor means but also the active elements are disposed in an operationally optimized manner on a compact device carrier. It has been shown that with the inventive apparatus the expenditure for adaptation is low, and therefore a high flexibility with regard to mission-dependent use results.

With the inventive apparatus it is possible to harmonize the axes of sensors and active elements, especially of the firing devices for active elements, taking into account correction for parallax, mounting angle, etc., right from the beginning in such a way that an expensive adjustment after installation of the apparatus on the object is eliminated. The apparatus can thus be configured and arranged in such a way that an observation of the threat, and the combating thereof, is made possible, independently of the installation site, over an azimuth angle of up to 360°. The apparatus has such a flexible configuration that it can be used not only on combat vehicles but also on stationary facilities. The interface to the carrier system that is provided can have a unitary configuration, so that the “self-sufficient, self-supporting platform” need not be embodied for a specific target system. Consequently, the configuration with sensors and active elements can be freely configured. The apparatus is conceived in such a way that it can be remotely operated accompanied by armored protection.

With the inventive apparatus, preferably disposed on and upon a device carrier are warning sensors, and in the region below the warning sensors adjustable firing devices for active elements that can be fired or launched, for example launchers for firing projectiles, and in particular in such a way that the field of viewing of the warning sensors is not limited in azimuth and elevation by the firing devices. At the top on the device carrier, in the region above the warning sensors, a unit for electronics/electro-optical elements can be disposed. As a consequence of the arrangement in various horizontal planes, it is achieved that sensors and active elements are not disrupted. By means of the firing devices for active elements that can be fired or launched, approaching or incoming guided missiles can be destroyed with pyrotechnical means. Thus, for example, a multi-spectral smoke screen can be produced. By means of electronic/electro-optical elements, it is possible, for example, to emit a closely bundled beam of light from a simultaneously operated or modulated light source, for example a laser, thereby destroying the guidance system of the guided missile.

Pursuant to a particularly preferred embodiment of the inventive apparatus, with which the device carrier is embodied as a narrow, upwardly directed unit, the device carrier is disposed on a base plate via a universal joint in such a way that at least a portion of the externally effective equipment of the apparatus can be pivoted upwardly and downwardly.

By means of the pivoting-up, one obtains different height levels during operation for viewing and action axes, thereby precluding an influencing of the sub-assemblies of the “self-sufficient, self-protecting platform” relative to one another, even over the entire azimuth range of 360°.

In the pivoted-out position, one obtains a relatively compact, low-built unit. This is particularly important during transport of combat vehicles on which is mounted “self-sufficient, self-protecting platform” for ensuring that the loading parameters are met.

In the following, an embodiment for an apparatus pursuant to the invention will be explained in greater detail with the aid of the accompanying drawings.

The drawings show:

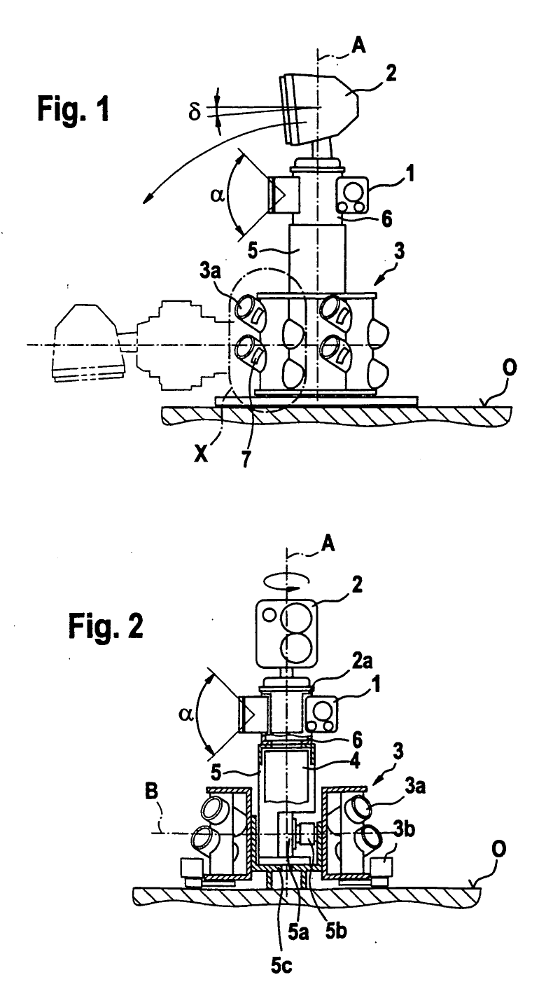

FIG. 1 in a side view, a self-sufficient, self-protecting platform pursuant to the invention;

FIG. 2 the self-protecting platform of FIG. 1 in a partially sectioned front view;

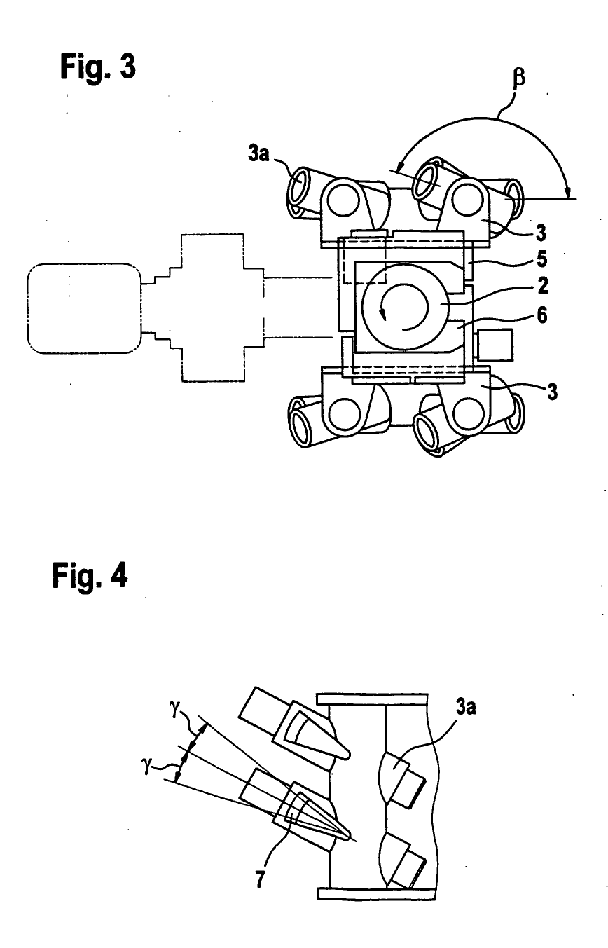

FIG. 3 the self-protecting platform of FIGS. 1 and 2 in a plan view;

FIG. 4 the region X from FIG. 1 in a partially sectioned illustration;

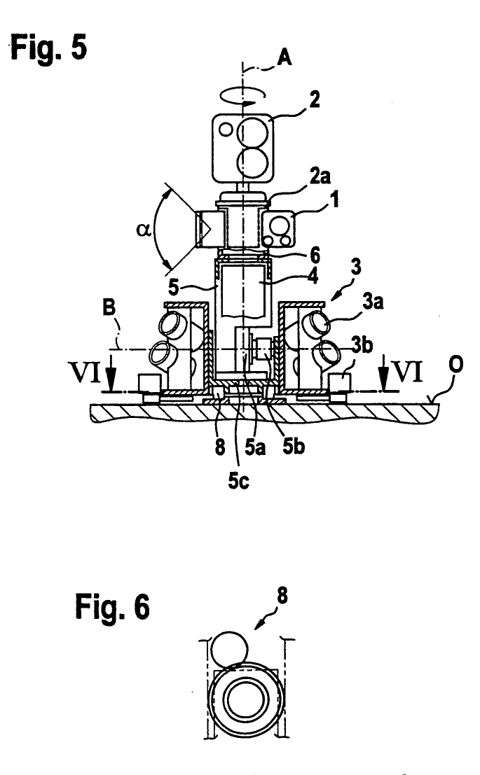

FIG. 5 in an illustration analogous to FIG. 2, a variant of the embodiment of FIGS. 1 to 4;

FIG. 6 a partial section through the embodiment of FIG. 5 taken along the line VI-VI in FIG. 5.

Illustrated in FIGS. 1 to 4 is an apparatus for protecting objects against ammunition in the form of guided missiles; in the following, the apparatus is called “self-sufficient, self-protecting platform”. The apparatus is disposed on the surface O of an object, for example a combat vehicle, that is not illustrated in greater detail. The apparatus has a device carrier 5 that is embodied as a narrow, upwardly directed unit, and that is connected via a universal joint 5a with a base plate 5c that is fixedly disposed on the surface O. By means of a drive mechanism 5b, the device carrier 5 is pivotable about the axis B of the universal joint 5a, out of the pivoted-up position illustrated by solid lines in FIGS. 1 to 3, by 90° into a pivoted-out position illustrated in dot-dash lines. Disposed on the device carrier 5 is a housing 6 into which, depending upon how it is equipped, one to four warning sensors 1 are laterally integrated. On the housing 6, by means of a directional drive 2a, a unit 2 of electronic/electro-optical active elements 2, which unit can be aligned in azimuth, is rotatable about the axis A of the device carrier 5, and is pivotable in elevation about the angle ±δ. The warning sensors 1 sense over a viewing angle α. There thus results on the device carrier 5 a compact unit that comprises warning sensors 1 and electronic/electro-optical active elements 2, and that is grouped together in the housing 6.

The arrangement of the electronic/electro-optical active elements 2 above the warning sensors 1 enables an unlimited orientation range of these active elements 2 in azimuth. No masking or screening due to other components of the self-protecting platform occurs.

The field of view α of the warning sensors 1 is also not limited in azimuth and elevation by any other components.

The space in the region below the warning sensors 1 is used for the installation of the units 3 having firing devices 3a for active elements that can be fired or launched, whereby in the illustrated embodiment the firing devices are in the form of projectile canisters or launchers for firing projectiles. In the illustrated embodiment, a respective unit 3 having a plurality of firing devices 3a is installed on both sides of the device carrier 5. The individual firing devices 3a, in other words the launchers, can be adjusted in elevation via an adjusting device 7. The units 3 can be adjusted in azimuth via drive devices 3b (e.g. electrical locking or indexing mechanism having springs). With this arrangement, the ability to adjust the firing devices in azimuth and elevation, i.e. to the left and to the right next to the device carrier 5, is not limited. The adjustment range of the firing devices 3a in elevation is indicated in FIG. 4 by γ. The adjustment range of the units 3 in azimuth is indicated in FIG. 3 by β.

The device carrier 5 is configured such that directly below the housing 6 there results an enclosed, freely available installation space 4. This installation space 4 is protected by the device carrier 5 against external influences, and can be used for the integration of electrical and electronic components, in other words for the electronics, energy distributors, position sensors, cables etc.

By arranging all of the described components on the common device carrier 5, extensive adjusting steps of warning sensors 1 and active elements 2 and/or 3a relative to one another are eliminated.

With the adaptation of the self-sufficient, self-protecting platform on vehicles, the position of the device carrier 5 where it is pivoted-out about the axis B of the universal joint 5a enables loading parameters to be met. The operability of the adjustable units 3 for the firing devices 3a, which are arranged in such a way that they do not obstruct the indexing or retraction of the device carrier 5, remains even in the retracted position of the device carrier 5.

Integrated in the base of the universal joint 5a are the mechanical and electrical interfaces.

Illustrated in FIGS. 5 and 6 is a variant of the embodiment of FIGS. 1 to 4 that differs from this embodiment in that the base plate, which is designated 5c′ in FIG. 5, is connected with the surface O of the object via a directional drive 8 so as to be adjustable in azimuth.

The remaining portions of the embodiment of FIGS. 5 and 6 correspond exactly to the components of the embodiments of FIGS. 1 to 4, and carry the same reference numerals. With the embodiment of FIGS. 5 and 6, it is possible to adjust the entire self-protecting platform in the direction of the main threat that is anticipated. This is necessary if as a consequence of a partial equipping with warning sensors 1, the full range in azimuth cannot be sensed.

1-10. (canceled)

11. An apparatus for protecting an object against ammunition in the form of guided missiles, comprising:
a device carrier that is adapted to be disposed or mounted on the object that is to be protected;
at least one warning sensor for detecting an incoming guided missile, wherein said at least one warning sensor is disposed on said device carrier; and
active elements for repelling the guided missile, wherein said active elements are disposed on said device carrier.

12. An apparatus according to claim 11, wherein in a region below said at least one warning sensor, firing devices for active elements that can be fired, and which are adjustable at least in elevation, are disposed in such a way that a field of viewing of said at least one sensor is not limited in azimuth and elevation.

13. An apparatus according claim 12, wherein said firing devices are embodied as launchers for firing projectiles.

14. An apparatus according to claim 12, wherein respective units comprised of a plurality of said firing devices are disposed on a plurality of sides of said device carrier.

15. An apparatus according to claim 12, wherein a unit of electronic/electo-optical active elements that is adjustable at least in azimuth is disposed on said device carrier in a region above said at least one warning sensor.

16. An apparatus according to claim 11, wherein said device carrier, in a region below said at least one warning sensor, is provided with an enclosed installation space for receiving electrical and electronic components.

17. An apparatus according to claim 15, wherein said device carrier is embodied as a narrow, upwardly directed unit on which a housing is mounted, wherein said unit of electronic/electro-optical is disposed above said housing, wherein said housing contains a directional drive for said unit of electronic/electro-optical elements, wherein said at least one warning sensor is disposed in sides of said housing, wherein in an upper portion of said device carrier, below said housing, an installation space is provided for receiving electrical and electronic components, and wherein on opposite sides of a lower portion of said device carrier, units having said firing devices for launchable active elements are disposed.

18. An apparatus according to claim 7, wherein said device carrier is disposed on a base plate via a universal joint, and wherein on said base plate, in a direction of an axis of said universal joint, said units having said firing devices are disposed in such a way that said device carrier, together with said housing, said at least one warning sensor, and said unit for electronic/electro-optical active elements are pivotable, via a drive mechanism, out of an upright position, about 90°, into a pivoted-out position.

19. An apparatus according to claim 18, wherein mechanical and electrical interfaces are integrated into a base of said universal joint.

20. An apparatus according to claim 18, wherein said base plate is connected with the object via a directional drive so as to be adjustable in azimuth.
